(19) United States
(12) Patent Application Publication
(10) Pub. No.: US 2014/0297485 A1
(43) Pub. Date: Oct. 2, 2014

(54) Initial Calibration of Asset To-Be-Tracked

(71) Applicant: LEXMARK INTERNATIONAL, INC., Lexington, KY (US)

(72) Inventors: Forrest Lane Steely, Lexington, KY (US); John Douglas Anderson, Lexington, KY (US); Brent Allen Schanding, Winchester, KY (US)

(73) Assignee: Lexmark International, Inc., Lexington, KY (US)

(21) Appl. No.: 13/853,573

(22) Filed: Mar. 29, 2013

(51) Int. Cl. G06Q 10/08

(52) U.S. Cl. CPC G06Q 10/087
USPC 705/28

(57) ABSTRACT

A mobile computing device hosts an operating system and mobile applications. A calibrating application causes display of an interface for entry of administrative data regarding an asset to-be-tracked. A positioning system defines locations of the asset in geospatial coordinates. The calibrating application displays a mapping function that shows on a map an initial location of the asset. Users adjust the initial location to a proper location on the map with a hand gesture on a display surface of the mobile computing device. A delta is noted between the initial and proper locations that the calibrating application applies later during tracking of the asset to precisely establish a whereabouts of the asset in its tracking environment. Other embodiments note techniques for entering administrative data.

### FIELD OF THE INVENTION

The present invention relates to mobile computing devices, such as smart phones. It further relates to applications on mobile devices that conveniently provide initial calibration of assets to-be-tracked. Enrollment of the asset into the application and associating initial and adjusted geospatial coordinates define various embodiments.

### BACKGROUND

Locating systems are known for tracking assets. Computing devices determine existence, whereabouts and timing of items being transported or stored. Companies track items in static environments such as stores and warehouses, etc., for control of inventory. Companies also track items in dynamic environments involving complex positioning of cars, trucks, planes, etc. moving unconstrained around the globe. In any scheme, items are first enrolled in an asset management system.

Technicians identify assets to-be-tracked and note their initial position. If positioning is derived from “location aware” electronics, such as handheld GPS devices, accuracy is limited to a range of plus or minus approximately twenty-five feet (Global Positioning System (GPS) Standard Positioning Service Performance Standard, 4th Edition, September 2008, published by the United States Department of Defense). While such is sufficient for noting the whereabouts of relatively large objects, such as trucks, it is largely insufficient for finding/tracking small or miniature assets in rooms full of such assets. As items sometimes also travel vertically in space between floors of buildings or parking garages and/or to sides of doors or walls opposite their original positions, users often have difficulty finding both large and small assets despite their existence within the standards noted above. As electronic signals from GPS devices have difficulty negotiating past walls, concrete, steel, and the like, GPS accuracy tends to suffer indoors which further complicates tracking in building or city environments.

If positioning of assets is derived manually from technicians, such as by cross-referencing physical maps and floor plans, accuracy is further diminished. Warehouses and office floors often look similar in layout to other warehouses and office floors on campuses and technicians require proper orientation when not in familiar settings. There is also difficulty for technicians in actually obtaining maps in the first place. Not only do the maps not exist in some environments, but technicians need to learn how and where to obtain them. This wastes valuable time during enrollment.

In other art, some assets are known to “self enroll.” Technicians attach transponders to assets-of-interest and multiple point sources interrogate the transponder to automatically triangulate an initial location for the asset. These environments, however, require pre-positioned and calibrated communications infrastructure to already exist. It requires enormous expense and great complexity to implement. It is also an insufficient technique for tracking assets that move beyond the confines of the infrastructure.

What is needed is a simple enrollment technique that defines an asset's relative location within a tracking environment regardless of the infrastructure surrounding it. What is also needed is a system to more accurately establish an asset's whereabouts within a margin of tolerance tighter than existing art, especially in situations where assets move vertically in three-dimensional space. Additional benefits and alternatives are also sought when devising solutions.

### SUMMARY

The above-mentioned and other problems are solved by methods and apparatus for initially calibrating an asset to-be-tracked. In a representative embodiment, a mobile computing device hosts an operating system and mobile applications. A calibrating application causes display of an interface for entry of administrative data regarding an asset to-be-tracked. The data includes make, model, serial number, or the like. A positioning system defines locations of the asset in geospatial coordinates, such as latitude/longitude. The calibrating application displays a mapping function that shows on a map an initial location of the asset. Users adjust the initial location to a more accurate location on the map with a hand gesture on a display surface of the mobile computing device. A delta is noted between the two locations and is applied later during tracking of the asset to precisely establish its whereabouts. The delta is defined variously such as noting differences between original and later latitudes/longitudes, distance/theta measurements, etc. Software, executable code, interfaces, mobile applications, and computing system environments typify the embodiments.

Other embodiments note techniques for entry of administrative data of the asset. These include but are not limited to manual entry on an enrollment page of the calibrating application, scanning bar codes of the asset, reading RFID tags of the asset, transmitting/receiving data with near field communication modules of the asset and the mobile computing device, and mobile capture (with optical character recognition) of data from a nameplate of the asset.

These and other embodiments are set forth in the description below. Their advantages and features will become readily apparent to skilled artisans. The claims set forth particular limitations.

### BRIEF DESCRIPTION OF THE DRAWINGS

FIG. 1 is a diagrammatic view of a computing system environment for downloading a calibrating application onto a mobile computing device;

FIG. 2 is a diagrammatic view of an interface for calibrating an asset to-be-tracked in its locating environment, including initial enrollment of the asset on a mobile computing device and associating geospatial coordinates;

FIG. 3 is a diagrammatic view for communicating a mobile computing device to an asset management station remote from the mobile computing device;

FIG. 4 is a diagrammatic view of a mapping function showing an initial location of an asset to-be-tracked on a map corresponding to a coarse calibration of the asset during initial enrollment and a proper location of the asset as adjusted by a user; and

FIG. 5 is a flow chart of actions for initially calibrating and tracking assets.

### DETAILED DESCRIPTION OF THE ILLUSTRATED EMBODIMENTS

In the following detailed description, reference is made to the accompanying drawings where like numerals represent like details. The embodiments are described in sufficient detail to enable those skilled in the art to practice the invention. It is to be understood that other embodiments may be utilized and that changes may be made without departing from the scope of the invention. The following detailed description, therefore, is not to be taken in a limiting sense and the scope of the invention is defined only by the appended claims and their equivalents. In accordance with the features of the invention, methods and apparatus are described for initial calibration of assets in locating systems.

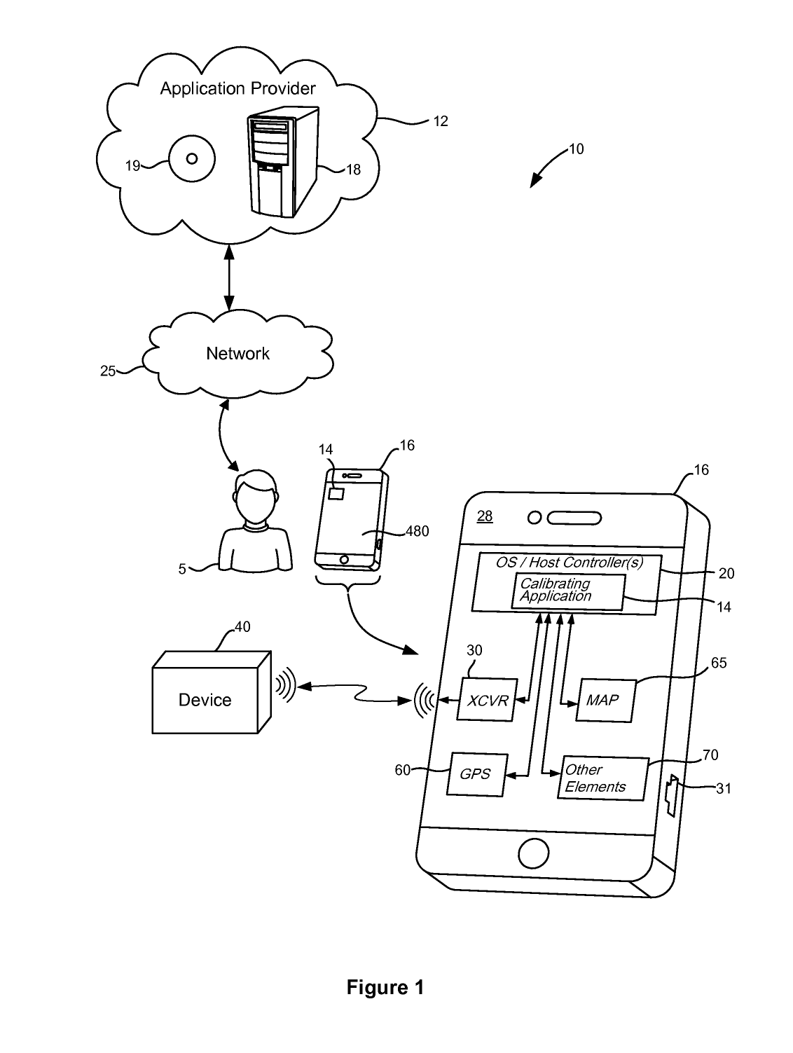

With reference to FIG. 1 a computing system environment 10 for obtaining mobile applications (colloquially “mobile apps”) includes a service provider 12. The provider makes available a calibrating application 14 that users 5 download onto a mobile computing device 16. The download resides as executable code on a computing device 18 such as a server or imprinted on a computer readable medium 19 such as a CD, smart card, USB stick, etc. Users retrieve the medium and load the calibrating application directly onto their mobile device, usually with the assistance from still another computing device (not shown). More popularly, users execute a series of functions on their mobile device and obtain the requisite code by way of an attendant computing network 25. The network includes or not a variety of software such as an “app store” and hardware such as routers, servers, switches, desktop/laptop computers, phone transmission towers, satellites, etc. The connections are wired and wireless communications between a few or many such devices in an internet, intranet or other environment. Skilled artisans know the process and environment for downloading applications.

Upon successful receipt of the calibrating application 14, the mobile computing device 16 hosts it on one or more controllers 20 resident in a housing 28. The controller(s) also host an operating system (O.S.) and one or more additional mobile applications, as is typical. One or more transceiver(s) 30 reside in the housing 28 to communicate information from the calibrating application 14 to another device 40 external to the housing 28. The other device is any of a variety but is commonly another mobile computing device, transmission tower, base station, computer, router, communications terminal, etc. Under a variety of situations, the transceiver sends and receives signals to the device via communication techniques such as Bluetooth, Wi-Fi (wireless local area network), near field communication (NFC), etc.

A positioning system 60 also resides in the mobile computing device 16 and communicates with the calibrating application 14. It is integrated in smart phones to establish a whereabouts of the housing of the phone at all times. It may be also used to establish a whereabouts of a destination or other designated position that is not necessarily the location of the phone at that time. The position may be displayed on a map from a mapping function 65 that also communicates with the calibrating application. The unit of measurement from the positioning system is any of a variety recognizable by the calibrating application but coordinates from a GPS (global positioning satellite) module are typical. These include but are not limited to absolute locations such as latitude/longitude and altitude coordinates about the world, relative locations noted by “pin drops” or other designators such as flags, stars, etc. placed on maps from the mapping function 65, or Universal Transverse Mercator (UTM) coordinates noted relative to a mapping feature in one or more map zones.

At other elements 70, the calibrating application 14 leverages still other functionality of smart phones. This includes but is not limited to functions found in address books, lists of contacts, calendars, clocks, cameras, photos, notifications, messages, compasses, etc. Slot 31 may provide access to further functions or data by way of an inserted card or wired interface to another computing device.

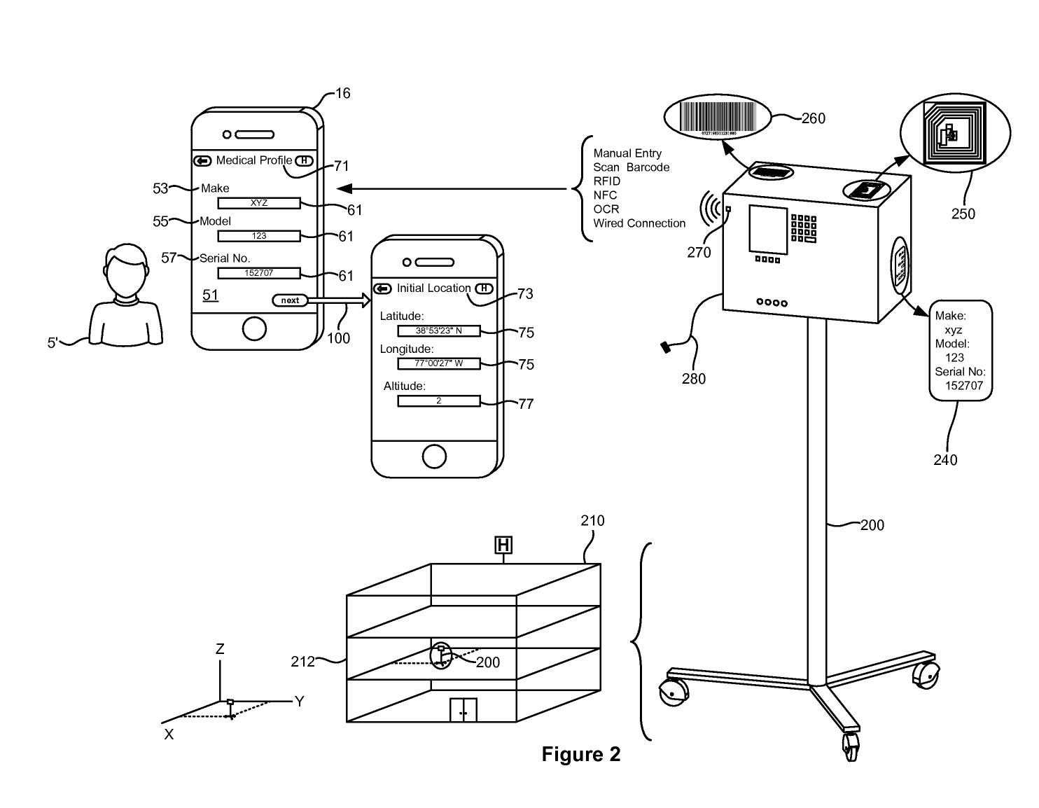

With reference to FIG. 2, the calibrating application 14 causes display of an interface 51 on the mobile device 16 where technicians 5′ enter administrative data regarding an asset to-be-tracked 200. The data is as simple or complex as necessary to uniquely identify the asset in a manner suitable for tracking. In one embodiment the data corresponds to the make 53, model 55 and serial number 57 of the asset that is typically found on a nameplate 240. In another embodiment, fungible items or commodities in a container to-be-tracked have no make, model or serial number so the administrative data representatively corresponds to bin number, date of manufacture, date of harvest, lot number, expiration date, sell-by date, or the like. Depending on the asset, still other administrative data includes or not a location of manufacture, part number, milling date, size, amount, capacity, weight, aisle number, room number, client number, or the like. Without limitation on the type or amount of data, the administrative data is entered into the calibrating application.

To do so, the operator of the mobile device brings up the “registration enrollment” page 71 of the calibrating application. Once there, they cause entry of the administrative data of the asset into the page. The following are representative ways in which this can be accomplished. One, the technician enters the data manually into fields 61 of the page 71 using a keyboard (not shown) of the mobile computing device. Two, the technician uses the mobile computing device to scan a barcode 260 of the asset. The barcode is decoded into the characters of the administrative data and automatically populated into the fields of the application. Three, the technician uses the smart phone to take a picture of the nameplate 240 and an OCR (Optical Character Recognition) routine recognizes the characters in the administrative data. The calibrating application automatically enters the recognized characters into requisite fields of the application. The picture, or “mobile capture,” originates from a camera feature of the phone while the OCR routine can be embedded as part of the calibrating application. Four, the technician obtains administrative data from the asset by radio frequency means 270 such as used with NFC (Near Field Communication) transmitters/receivers or an RFID tag 250. Either or both of these can be decoded by the transceiver 30 of the smart phone (FIG. 1). A physical connection by way of wire 280 may be also used to populate the requisite data of the asset to-be-tracked.

Once obtained, the technician advances 100 the registration enrollment page to page 73 noting the “initial location” of the asset 200. To illustrate the concept, skilled artisans will recognize that the asset to-be-tracked is any of a variety that can travel in a variety of locations. However, a pump is described herein for use in a hospital environment 210. The pump is located on a second floor 212 of the hospital. An X-Y-Z coordinate system illustrates the three-dimensional planes of the hospital and the pump. The X-Y plane denotes a coordinate plane where a positioning system 60 (FIG. 1) provides latitude and longitude, while the Z-direction notes an altitude or height of the pump above the ground level (AGL). The height can be measured in actual distance from a base of the building, say ten feet, but can also represent a number of floors, say 2^{nd} floor, of a building. It can also reflect a height relative to another baseline, such as mean sea level (MSL) based on barometric pressure, or can be an estimate of height noted by the technician. In any scheme, the calibrating application invokes the functionality of the positioning system so that a gross or coarse calibration of the asset is obtained. The positioning system first ascertains the geographic location of the technician's phone from input of the positioning system and automatically supplies it to coordinate fields 75. If the positioning system also has an altitude it supplies it too. Otherwise, the technician fills in this field with either a height or a floor number. As the technician is physically nearby the asset to-be-tracked, the location of the phone makes for an adequate coarse approximation of the location of the asset at this time.

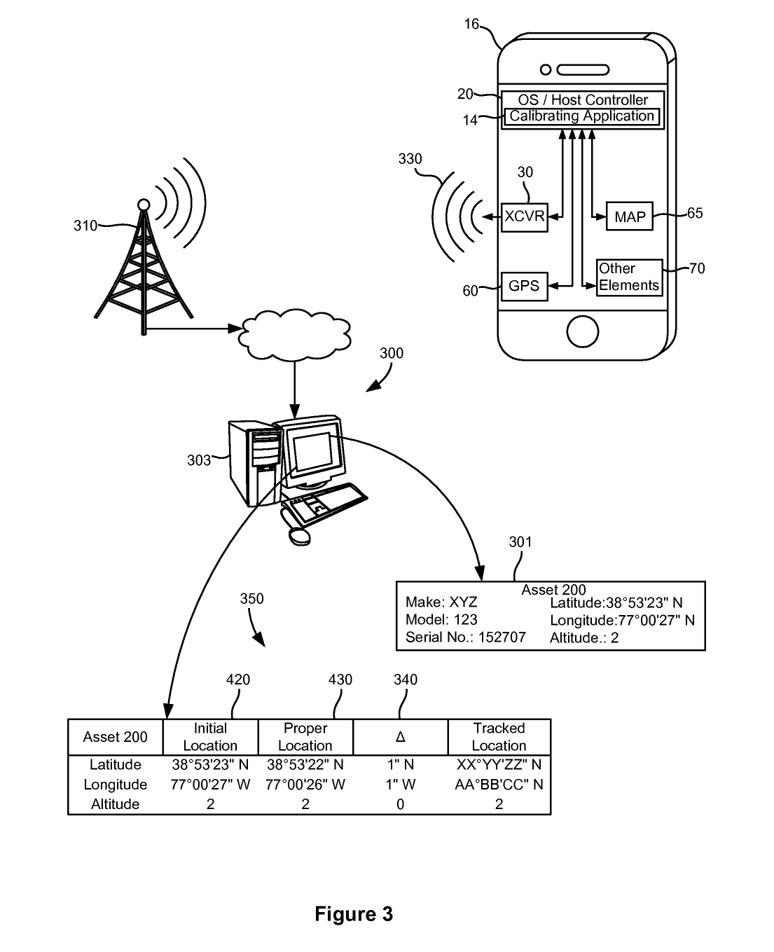

With reference to FIG. 3, the calibrating application sends the gathered enrollment information to an asset management system 300 where it and other records of all assets under management are maintained 301. They are stored in a database of a server or other computing device 303. The asset management system resides in the same locating environment as the asset to-be-tracked (e.g., hospital 210, FIG. 2) or remote from it. If remote, a computing environment 310 similar to that in FIG. 1 may be used to transmit and receive signals 330 between the mobile computing device and the asset management system.

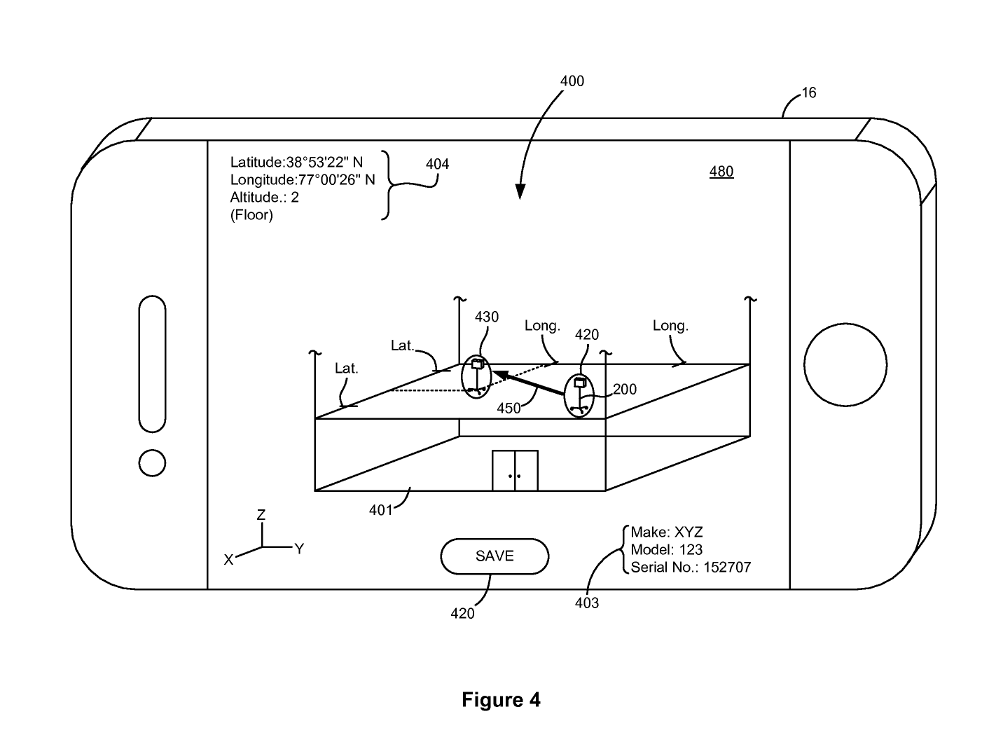

With reference to FIG. 4, the asset management system applies the initial location of the asset to-be-tracked to a map 400 from the mapping function that the technician accesses from their calibrating application on their mobile computing device 16. The map is any of a variety but contemplates a floor plan 401 of the building where the asset is located as well as superimposed lines or tick marks of latitude (lat) and longitude (long). It is preferred too that the administrative data 403 of the asset be contemporaneously displayed to remind the technician of which asset(s) are currently being viewed on the map. The technician visually inspects the initial location 420 of the asset 200 and determines whether such is properly applied to the map or not. If not, the technician adjusts the asset to a more accurate or proper location 430 on the map. They do this by applying a hand gesture 450 to a display surface 480 of the mobile computing device. The gesture can take the form of hook-and-drag, tap and double-tap, swipe or other gesture recognized by the calibrating application. Given that the initial estimate of the geospatial location of the asset 200 in its physical environment 210 (FIG. 2) is only accurate within a GPS range of twenty five feet or more in the horizontal (X-Y) plane and even more in the vertical dimension (Z), some error is to be expected from the lack of precision of the initial estimate. In turn, some amount of correction of the initial location to a proper location is expected by the technician during the enrollment process. As the technician is physically nearby the asset during enrollment, making corrections in this fashion is a very simple task. When satisfied with the adjustment, the technician “saves” the enrollment by pressing button 420 or by engaging any other suitable end-of-process mechanism. The geospatial set of coordinates 404 for the asset can be shown and updated in real time as the user makes adjustments.

As there now exists a difference in location between the initial location of the asset obtained during its coarse calibration and its proper location obtained from the technician during adjustment, the calibrating application and/or asset management system calculates an error (delta) 340 between the two as shown in FIG. 3. The delta can be defined in distance measurements in a variety of schemes (X-Y-Z) (r/theta) (vector math) etc., latitude/longitude corrections or other. It can be saved in an interface 350 along with the administrative data of the asset.

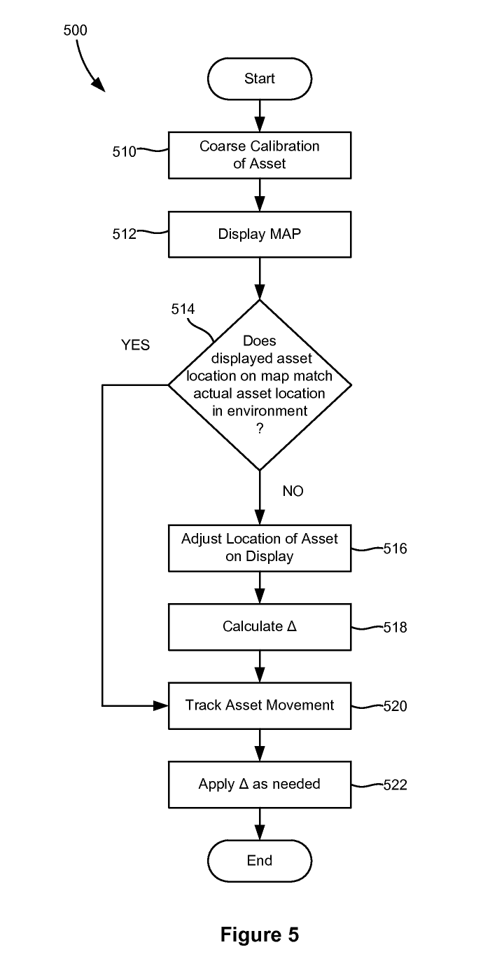

With reference to FIG. 5, a routine for initially calibrating an asset to-be-tracked is given as 500. The technician first establishes a coarse calibration 500 for the asset upon the calibrating application invoking the positioning system of the mobile device to get a location of the mobile device. At 512, a map (400) gets displayed to the technician by a mapping function (65) that notes the initial location (420) of the asset. If the display of the asset (200) on the map (400) is correct at 514, further tracking of the asset can occur at 520. If not, the technician adjusts (450) the initial location (420) of the asset on the map to a proper location (430) on the map at 516. The error (delta) between the two positions is calculated at 518. Upon further tracking of the asset (according to any techniques known or hereafter developed), the delta can be applied to the tracking routine at 522. In this way, whatever errors are initially introduced during coarse calibration are not carried through during later tracking of the asset. Instead, a more precise geospatial tracking of the asset is obtained for all times of asset movement. The asset management system keeps a record of each of these items, including the relative location of the asset on the floor plan in its environment (e.g., hospital 200) and its absolute geospatial location (FIG. 3).

Relative advantages of the many embodiments should now be apparent to skilled artisans. They include but are not limited to: (1) providing a real time locating system to precisely establish a whereabouts of an asset to-be-tracked; (2) providing a simple technique for adjusting an initial, coarse estimate to a more accurate and proper location of an asset that later undergoes tracking; and (3) associating a relative location of an asset in a floor plan of a building, for example, to its absolute geospatial coordinates with a high degree of precision to provide a better, global view of assets under management in a tracking environment.

The foregoing illustrates various aspects of the invention. It is not intended to be exhaustive. Rather, it is chosen to provide the best illustration of the principles of the invention and its practical application to enable one of ordinary skill in the art to utilize the invention. All modifications and variations are contemplated within the scope of the invention as determined by the appended claims. Relatively apparent modifications include combining one or more features of various embodiments with features of other embodiments.

1. A mobile computing device for initially calibrating an asset to-be-tracked, comprising:
a housing;
one or more controllers in the housing to host an operating system and one or more mobile applications; and
a positioning system in the housing defining locations in geospatial coordinates,
wherein said one or more mobile applications includes a calibrating application configured to cause display of an interface for receipt of administrative data about the asset to-be-tracked and to receive geospatial coordinates from the positioning system regarding a coarse calibration of the asset to-be-tracked, the calibrating application further configured to cause displaying a mapping function on the mobile computing device that shows on a map an initial location of the asset to-be-tracked corresponding to the coarse calibration.

2. The mobile computing device of claim 1, wherein the calibrating application is further configured to enable users to adjust the initial location to a proper location if the initial location on the map is incorrect.

3. The mobile computing device of claim 2, wherein the calibrating application is configured to recognize a hand gesture by the user on a display surface of the mobile computing device for identifying a user adjustment of the asset to-be-tracked from the initial location to the proper location.

4. The mobile computing device of claim 1, wherein the positioning system automatically populates the geospatial coordinates for the asset to-be-tracked corresponding to the coarse calibration.

5. The mobile computing device of claim 1, further including a transceiver in the housing to communicate with a communications terminal external to the housing of the mobile computing device, the transceiver configured to transmit the administrative data and the coarse calibration to the communications terminal.

6. The mobile computing device of claim 1, wherein the calibrating application is configured to receive the administrative data by way of the mobile computing device scanning a bar code of the asset to-be-tracked.

7. The mobile computing device of claim 1, wherein the calibrating application is configured to receive the administrative data by way of the mobile computing device reading an RFID tag of the asset to-be-tracked.

8. The mobile computing device of claim 1, wherein the calibrating application is configured to receive the administrative data by way of the near field communications from the asset to-be-tracked.

9. The mobile computing device of claim 1, wherein the calibrating application is configured to receive the administrative data by way of a mobile capture from a nameplate of the asset-to-be-tracked.

10. The mobile computing device of claim 1, wherein the calibrating application is configured to display a page of the interface to the user for manually entering the administrative data of the asset to-be-tracked.

11. A calibrating application for an asset to-be-tracked available on a computer readable medium or hosted on a computing device having memory for download onto a mobile computing device, comprising:
executable code for displaying an interface to users to receive a coarse calibration of the asset to-be-tracked;
executable code for displaying a mapping function on the mobile computing device that shows on a map an initial location of the asset to-be-tracked corresponding to the coarse calibration; and
executable code for users to adjust the initial location to a proper location if the initial location on the map is incorrect.

12. The calibrating application of claim 11, further including executable code for communicating with a transceiver in the mobile computing device for transmitting the coarse calibration from the mobile computing device to an asset management station remote from the mobile computing device.

13. The calibrating application of claim 11, further including executable code for calculating a delta between the initial location and the proper location.

14. The calibrating application of claim 13, further including executable code for converting the delta into geospatial coordinates.

15. The calibrating application of claim 11, further including executable code recognizing a hand gesture on a display surface of the mobile computing device for identifying a user adjustment on the map from the initial location to the proper location.

16. The calibrating application of claim 11, further including executable code for communicating with a positioning system in the mobile computing device that automatically populates a geospatial set of coordinates corresponding to the coarse calibration.

17. The calibrating application of claim 11, further including executable code for receiving in the interface administrative data of the asset to-be-tracked.

18. A calibrating application for an asset to-be-tracked available on a computer readable medium or hosted on a computing device having memory for download onto a mobile computing device, comprising:
executable code for displaying an interface to users to receive administrative data of the asset to-be-tracked;
executable code for receiving a coarse calibration of the asset to-be-tracked; and
executable code for displaying a mapping function on the mobile computing device that shows on a map an initial location of the asset to-be-tracked corresponding to the coarse calibration.

19. The calibrating application of claim 18, further including executable code for users to adjust the initial location to a proper location if the initial location on the map is incorrect.

20. The calibrating application of claim 18, further including:
executable code for communicating with a positioning system of the mobile computing device to automatically receive a geospatial set of coordinates corresponding to the coarse calibration;
executable code recognizing a hand gesture on a display surface of the mobile computing device for identifying a user adjustment on the map from the initial location to the proper location; and
executable code for calculating a delta between the initial location and the proper location that is converted into a second geospatial set of coordinates.
